(19) United States
(12) Patent Application Publication
(10) Pub. No.: US 2025/0185845 A1
(43) Pub. Date: Jun. 12, 2025

(54) NEW TYPE OF DUAL-CHAMBER STEAM AIR FRYER

(71) Applicant: ZHEJIANG BIYI ELECTRIC APPLIANCE CO., LTD., Yuyao (CN)

(72) Inventors: Kaimong MAN, Yuyao (CN); Hongxian LOU, Yuyao (CN); Hao ZANG, Yuyao (CN)

(73) Assignee: ZHEJIANG BIYI ELECTRIC APPLIANCE CO., LTD., Yuyao (CN)

(21) Appl. No.: 18/795,584

(22) Filed: Aug. 6, 2024

(30) Foreign Application Priority Data
Dec. 8, 2023 (CN) 2023233515145

(51) Int. Cl. A47J 37/06; A47J 27/04; A47J 27/12; F24C 15/32

(52) U.S. Cl. CPC A47J 37/0641; A47J 27/04; A47J 27/12; F24C 15/325; F24C 15/327; A47J 2027/043

(57) ABSTRACT

A dual-chamber steam air fryer, aimed at improving poor internal sealing structure designs in existing products, which have not optimized sealing for the pot or cooking chamber, and leads to inconvenient production and assembly, poor sealing effect, and high production costs. The fryer features a dual-chamber opening on one side of the body, with corresponding pans or pan assembles placed at the opening, The top of the body is equipped with a first water tank, or the bottom of the body is equipped with a second water tank. In the pans or pan assemblies, there is/are stainless steel heating insulation layer/layers. The lower side of the stainless steel heat-insulating inner layer, which is closer to the pan, is each equipped with sealing rings which protrude above the inner layers, reach the rim of the pans to form a relatively sealed, but not completed sealed space with the pans.

### TECHNICAL FIELD

The patent relates to a steam air fryer, specifically a new type of dual-chamber steam air fryer.

### BACKGROUND ART

The steam air fryer is a household appliance that combines the functions of an air fryer and a steam oven. The air fryer uses high-speed air circulation technology to fry food, resulting in food with 80% less fat compared to traditional deep fryers. It is easy to clean, safe, and economical, making it popular among consumers. Some air fryers have a steam function, such as the one disclosed in Chinese Patent Document with application No. 202110774047.3, granted on Dec. 30, 2022, titled “A Steam Air Fryer with Circulation Channel.” Others adopt a dual-chamber structure, like the one disclosed in Chinese Patent Document with application No. 202010692094.9, published on Jan. 18, 2022, titled “Air Fryer.” However, these products and similar ones have poor internal sealing structure design, especially the sealing structure above the inner pot, resulting in inconvenient production and assembly, poor sealing effect, and high production cost.

### SUMMARY OF THE INVENTION

To overcome the above deficiencies, the objective of the patent is to provide a new type of dual-chamber steam air fryer that addresses the poor internal sealing structure design of existing similar products, especially the poor sealing structure above the inner pot, which leads to inconvenient production and assembly, poor sealing effect, and high production cost. The objective is achieved through the following technical solution.

A new type of dual-chamber steam air fryer, characterized by a top cover on the body of the fryer, with dual chambers on one side of the body, each corresponding to a pan assembly with a pot. The top of the body has a first water tank, or the bottom has a second water tank. The first or second water tank is connected to the steam generator, water pump, and steam nozzle inside the body through a silicone hose. The steam nozzle is located on one side of the stainless steel heat-insulating inner layer above the pot. The design compromises: the stainless steel heat-insulating inner layer is set on both sides of the pot, with sealing rings at lower side of the heat-insulating inner layer. The ends of the sealing rings protrude above the stainless steel heat-insulating inner layer, sealing against the edge of the pot. This design a relatively sealed space with the pot. Unlike existing products, which mainly seal at the door frame, this steam air fryer only requires the upper chamber materials to be anti-rust, achievable with stainless steel heat-insulating inner layers, reducing the use of stainless steel parts and production costs. Existing products require all chamber materials to be anti-rust, resulting in higher production costs.

The sealing ring at the opening of the stainless steel heat-insulating inner layer above the pot in the body has a 1-3 mm gap reserved at the edge of the pot's mouth.

The pan assemblies comprises an outer pot and an inner pot or a tray, together with the sealing ring underneath the stainless steel heat-insulating inner layer, formed a relatively sealed space. Above the pot, there are heaters and metal fan blades, which are positioned above the heaters. Above the stainless steel heat-insulating inner layer are air guide chambers, each containing plastic centrifugal fan blades. Above the air guide chamber are motors, whose drive shafts are connected to the metal fan blades and plastic fan blades. Each of the air guide chamber's air outlet end is connected to the exhaust outlet of the airfrier housing; there is also an air outlet port on each side of the heat-insulating inner layer, this port is below the air guide chamber, and also connected to the exhaust outlet of the airfrier housing, Above is the main structure of air system with dual fan blades.

### ACCOMPANYING DRAWINGS

FIG. 1: Schematic diagram of the internal structure of the upper section of the device, without showing the top cover of the body.

FIG. 2: Schematic diagram of the lower side of the upper section of the device as shown in FIG. 1.

FIG. 3: External structure of the device.

FIG. 4: Cross-sectional view of the complete device, with section A framed.

FIG. 5: Enlarged diagram of section A in FIG. 4.

Reference Numerals and Names: 1 [symbol] Steam Generator, 2 [symbol] Water Pump, 3 [symbol] Steam Nozzle, 4 [symbol] Sealing Ring, 5 [symbol] First Water Tank, 6 [symbol] Second Water Tank, 7 [symbol] Air Guide chamber, 8 [symbol] Motor, 9 [symbol] Plastic Centrifugal Fan Blade, 10 [symbol] Metal Fan Blade, 11 [symbol] Stainless Steel Heat-Insulating Inner Layer, 12 [symbol] Heater, 13 [symbol] Inner Pot, 14 [symbol] Outer Pot.

### EMBODIMENTS

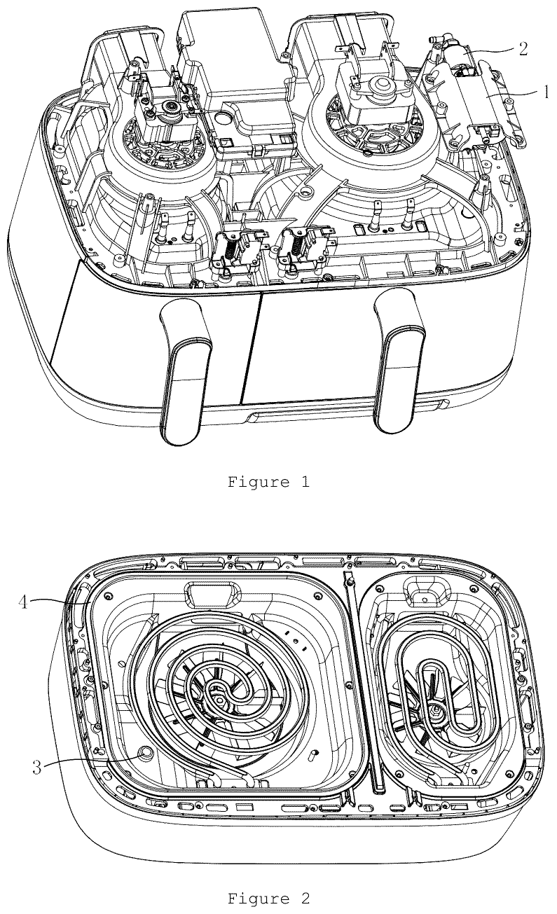

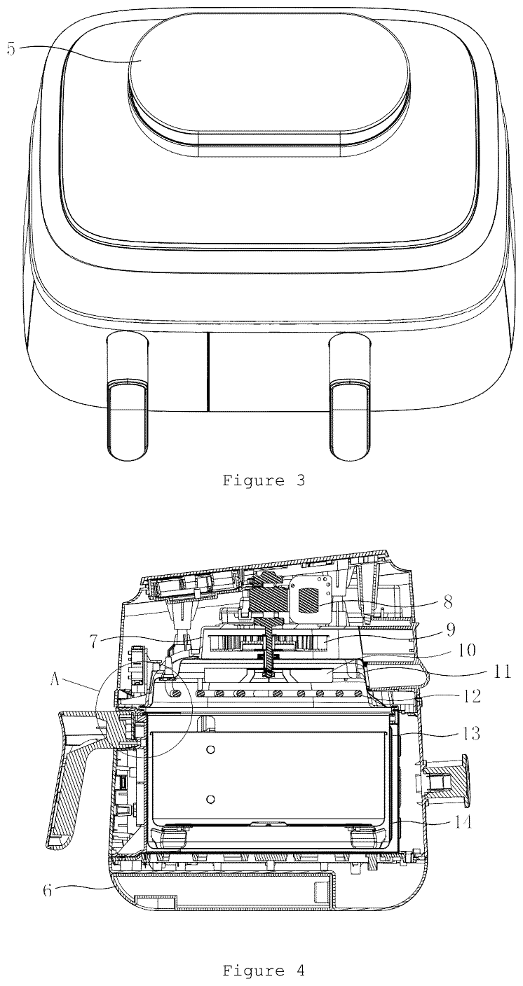

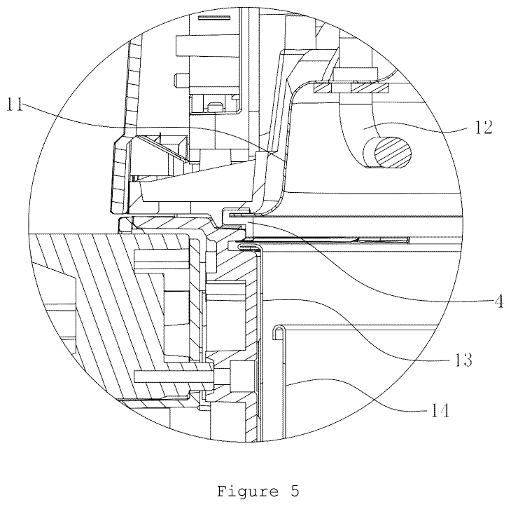

The structure and usage of the patent will be further described with reference to the drawings. As shown in FIGS. 1-5, the body of the steam air fryer is equipped with a top cover, with dual chambers on one side of the body, each corresponding to a pan assembly, each equipped with a pot and a handle on the outer side of the cover. The top of the body has a first water tank 5, or the bottom has a second water tank 6, connected to the steam generator 1, water pump 2, and steam nozzle 3 inside the body through a silicone hose. The steam nozzle is located below a stainless steel heat-insulating inner layer 11 above the pot. The stainless steel heat-insulating inner layer is fixing sealing rings 4 at its lower side. The ends of the sealing rings protrude above stainless steel heat-insulating inner layer, sealing against the edge rim of the pot.

The sealing ring fixed on the stainless steel heat-insulating inner layer above the pot has a 1-3 mm gap with the pot. The pan assembly consists of an outer pot 14 and an inner pot 13 or a crispy tray, and the inner pot or the tray is placed inside the outer pot. The stainless steel heat-insulating inner layer is equipped with heaters 12 and metal fan blades 10, which are positioned above the heaters. The top of the stainless steel heat-insulating inner layer inside the body is equipped with air guide chambers 7, each containing plastic centrifugal fan blades 9. Above the air guides are shaded pole motors 8, whose drive shafts are connected to both the plastic and metal fan blades. Each of the air guide chamber's air outlet end is connected to the exhaust outlet of the airfrier housing; there is also an air outlet port on each side of the heat-insulating inner layer, this port is below the air guide chamber, and also connected to the exhaust outlet of the airfrier housing The steam nozzle is located below the stainless steel heat-insulating inner layer, adjacent to heater.

When in use, by pressing the control panel buttons, the steam nozzle inside the body releases steam according to the programmed settings to cook food inside the pot with pure steam. The heaters, plastic centrifugal fan blades, and metal fan blades operate according to the programmed settings to cook the food inside the pot with, hot air, or a combination of steam and hot air for steam roasting. This steam air fryer thus has three major functions: pure steaming, steam roasting, and air frying.

1. A new type of dual-chamber steam air fryer, wherein the top of the fryer body is provided with a top cover, an opening on one side of the body housing and corresponding frying pan or pan assemblies are respectively placed at the opening. The top of the body is equipped with a first water tank (5), or the bottom of the body is equipped with a second water tank (6), The first or second water tank is connected to the steam generator (1), water pump (2), and steam nozzle (3) inside the body via silicone hoses. The steam nozzle is located on one side of the stainless steel heat insulating inner layer (11) above the pot. It is characterized that sealing rings (4) are located underneath the stainless steel heat-insulating inner layers (11). The sealing rings protrude above the stainless steel heat-insulating inner layers and reach the rim of the pot.

2. The new dual-chamber steam fryer of claim 1, wherein the sealing ring (4) which is underneath the steel heat-insulating inner layer (11) forms a sealed chamber with the pan while 1-3 mm space is left between the sealing ring and the pot's upper rim.

3. The new type of dual-chamber steam air fryer according to claim 1, comprises a pan assembly which may contain an outer pot (14) and an inner pot (13) or a tray (15). The ends of the sealing rings (4) are placed above the rim of the out pot and form a relatively sealed space.

4. The new type of dual-chamber steam air fryer according to claim 1, comprises heaters (12) and metal-fan blades (10), which are respectively provided under the stainless steel heat-insulating inner layers (11) above the pot The metal fan blades are positioned above the heaters. The top of the stainless steel heat-insulating inner layers inside the body are respectively provided with air guide chambers (7). The air guide chambers are each equipped with plastic centrifugal fan blades (9). The tops of the air guide chambers are respectively provided with motors (8), and the shaft of the motors are respectively connected to both the plastic and metal fan blades. The upper exhaust port on one side of the air guide chamber and the lower exhaust port on one side of the stainless steel heat-insulating inner layer are respectively connected to the body's air outlet, which is provided with an air outlet cover.

5. The new type of dual-chamber steam air fryer according to claim 1, comprises a steam nozzle (3), which is placed under the stainless steel heat-insulating inner layer (11), beside the heater (12).

6. The new type of dual-chamber steam air fryer according to claim 1, is designed with pan assemblies, which are of the same/different sizes, and with handles respectively provided on the outer sides.
